(19) United States
(12) Patent Application Publication
(10) Pub. No.: US 2020/0002789 A1
(43) Pub. Date: Jan. 2, 2020

(54) ALUMINUM ALLOY WIRE, ELECTRIC WIRE, AND WIRE HARNESS USING THE SAME

(71) Applicant: Fujikura Ltd., Tokyo (JP)

(72) Inventors: Tatsunori Shinoda, Chiba (JP); Naoki Kaneko, Chiba (JP)

(73) Assignee: Fujikura Ltd., Tokyo (JP)

(21) Appl. No.: 16/493,522

(22) PCT Filed: Jan. 16, 2018
(86) PCT No.: PCT/JP2018/000909

§ 371 Date: Sep. 12, 2019

(30) Foreign Application Priority Data
Mar. 15, 2017 (JP) 2017-049379

(51) Int. Cl. C22C 21/06; C22C 21/02; C22F 1/047; C22F 1/043; H01B 1/02; H01B 7/02

(52) U.S. Cl. CPC C22C 21/06; C22C 21/02; C22F 1/047; H01B 7/0045; H01B 1/02; H01B 7/02; C22F 1/043

(57) ABSTRACT

An aluminum alloy wire that includes unavoidable impurities, the aluminum alloy wire including: aluminum; and an added element that includes at least Si and Mg. An exothermic peak of the aluminum alloy wire is in a temperature range of 200 to 300° C. on a differential scanning thermal analysis curve.

### TECHNICAL FIELD

The present invention relates to an aluminum alloy wire, an electric wire, and a wire harness using the same.

### BACKGROUND

In recent years, from the viewpoint of satisfying weight reduction, bending resistance and impact resistance at the same time, as an element wire of an electric wire of a wire harness or the like, an aluminum alloy element wire made of an aluminum alloy has been used in place of a copper wire.

As such an aluminum alloy wire, for example, one disclosed in the following patent document 1 is known. The patent document 1 mentioned below discloses an aluminum alloy conductive wire including 0.2 to 0.8 mass % of Si, 0.36 to 1.5 mass % of Fe, 0.2 mass % or less of Cu, 0.45 to 0.9 mass % of Mg, 0.005 to 0.03 mass % of Ti, and the balance consisting of Al and inevitable impurities.

### PATENT DOCUMENT

Patent Document 1: JP 2010-265509 A

However, the aluminum alloy conductive wire described in the above-mentioned Patent Document 1 has had room for improvement in terms of tensile strength and elongation.

### SUMMARY

One or more embodiments of the present invention provide an aluminum alloy wire capable of improving tensile strength and elongation, an electric wire and a wire harness using the same.

Studies have been conducted on the form of precipitates that can affect tensile strength and elongation of the aluminum alloy wire, which is a precipitation strengthened type alloy. Here, the form of precipitates can be known by various exothermic peaks and endothermic peaks appearing in a differential scanning thermal analysis curve obtained by conducting a differential scanning thermal analysis of the aluminum alloy wire. It has been found that there is a correlation between presence or absence of an exothermic peak and tensile strength as well as elongation of the aluminum alloy wire in a case where the aluminum alloy wire has an exothermic peak in a specific temperature range in a differential scanning thermal analysis curve obtained by conducting a differential scanning thermal analysis of the aluminum alloy wire and has achieved completion of one or more embodiments of the present invention.

That is, one or more embodiments of the present invention provide an aluminum alloy wire comprising an aluminum alloy consisting of aluminum, an added element and inevitable impurities, the added element including at least Si and Mg, wherein the aluminum alloy wire has an exothermic peak in a temperature range of 200 to 300° C. in a differential scanning thermal analysis curve obtained by conducting a differential scanning thermal analysis.

According to the aluminum alloy wire of one or more embodiments of the present invention, tensile strength and elongation of the aluminum alloy wire can be improved.

In the above-mentioned aluminum alloy wire, the exothermic peak may be an exothermic peak derived (i.e., acquired) from the precipitation of a β″ phase.

In this case, compared to a case where the exothermic peak is not the exothermic peak derived from the precipitation of the β″ phase, tensile strength and elongation of the aluminum alloy wire can be further improved.

In the above-mentioned aluminum alloy wire, a calorific value in the exothermic peak may be 1.2 J/g or more.

In this case, compared to a case where the calorific value in the exothermic peak is less than 1.2 J/g, the elongation of the aluminum alloy wire can be more remarkably improved.

In the above-mentioned aluminum alloy wire, the calorific value in the exothermic peak may be 5.0 J/g or less.

In this case, the tensile strength of the aluminum alloy wire is further improved.

In the above-mentioned aluminum alloy wire, the content of Si in the aluminum alloy may be 0.45 mass % or more and 0.65 mass % or less, the content of Mg in the aluminum alloy may be 0.4 mass % or more and 0.6 mass % or less, the content of Cu in the aluminum alloy may be 0.3 mass % or less, the content of Fe in the aluminum alloy may be 0.4 mass % or less, and the total content of Ti and V in the aluminum alloy may be 0.05 mass % or less.

In this case, the aluminum alloy wire can have both tensile strength and elongation, and the aluminum alloy wire is better in conductivity.

In the above-mentioned aluminum alloy wire, the aluminum alloy may further contain Mg₂Si.

In this case, the tensile strength is further improved compared to a case where the aluminum alloy does not contain Mg₂Si.

Further, one or more embodiments of the present invention provide an electric wire comprising the above-mentioned aluminum alloy wire, and a coating layer covering the aluminum alloy wire.

According to the electric wire, the aluminum alloy wire can improve tensile strength and elongation. Therefore, the electric wire having such an aluminum alloy wire and the coating layer covering the aluminum alloy wire is useful as an electric wire disposed at a dynamic part to which bending or vibration is applied (for example, at a door part of an automobile, or in the vicinity of an engine of an automobile).

Further, one or more embodiments of the present invention provide a wire harness comprising a plurality of the electric wires.

According to the wire harness, the aluminum alloy wire can improve tensile strength and elongation. Therefore, the wire harness having a plurality of the electric wires each including such an aluminum alloy wire and a coating layer covering the aluminum alloy wire is useful as an electric wire disposed at a dynamic part to which bending or vibration is applied (for example, at a door part of an automobile, or in the vicinity of an engine of an automobile).

In addition, in one or more embodiments of the present invention, a differential scanning thermal analysis curve (hereinafter referred to as “DSC curve”) is a curve obtained by conducting a differential scanning thermal analysis under the following conditions using an aluminum alloy as a sample with a Differential Scanning calorimeter (DSC).

Standard material: Aluminum
Sample container: Aluminum
Temperature rising rate: 40° C./min
Sample weight: 20 mg
Atmosphere during analysis: Nitrogen

Further, in one or more embodiments of the present invention, the term “calorific value” means “heat of transfer” obtained by a method according to Japanese Industrial Standard (JIS) K7122.

According to one or more embodiments of the present invention, an aluminum alloy wire capable of improving tensile strength and elongation, an electric wire and a wire harness using the same are provided.

### BRIEF DESCRIPTION OF THE DRAWINGS

FIG. 1 is a cross-sectional view illustrating an aluminum alloy wire according to one or more embodiments of the present invention;

FIG. 2 is a cross-sectional view illustrating an electric wire according to one or more embodiments of the present invention; and

FIG. 3 is a cross-sectional view illustrating a wire harness according to one or more embodiments of the present invention.

### DETAILED DESCRIPTION

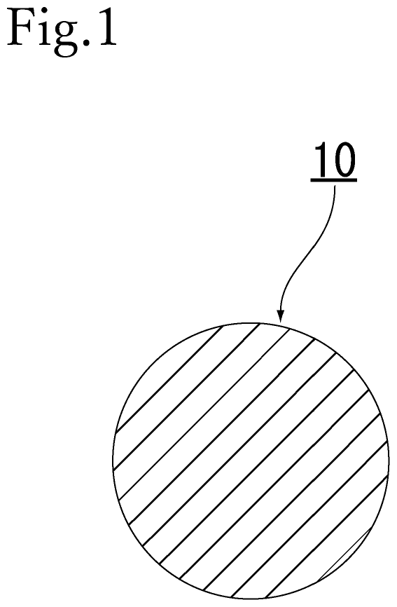

Hereinafter, an aluminum alloy wire according to one or more embodiments of the present invention will be described with reference to FIG. 1. FIG. 1 is a cross-sectional view illustrating the aluminum alloy wire.

<Aluminum Alloy Wire>

The aluminum alloy wire 10 illustrated in FIG. 1 includes an aluminum alloy consisting of aluminum, an added element and inevitable impurities and the added element includes at least Si and Mg. The aluminum alloy wire 10 has an exothermic peak in a temperature range of 200 to 300° C. in a DSC curve obtained by conducting a differential scanning thermal analysis.

According to the aluminum alloy wire 10, tensile strength and elongation can be improved.

Next, the aluminum alloy wire 10 will be described in detail.

<Aluminum Alloy>

Examples of the added element in the aluminum alloy include Si, Mg, Cu, Fe, Ti and V, but the added element in the aluminum alloy is required to include at least Si and Mg. That is, among the added elements, Si and Mg are essential added elements and the remaining elements are optional added elements. Here, the added element may include at least two kinds of optional added elements selected from the group consisting of Cu, Fe, Ti and V, in addition to the essential added elements composed of Si and Mg.

Furthermore, the inevitable impurities in the aluminum alloy are composed of a material different from that of the added element.

The content of Si in the above-mentioned aluminum alloy may be 0.45 mass % or more and 0.65 mass % or less. In this case, compared to a case where the content of Si is less than 0.45 mass %, it is possible to achieve both excellent tensile strength and elongation in the aluminum alloy wire 10, and compared to a case where the content of Si is more than 0.65 mass %, the aluminum alloy wire 10 is excellent in conductivity. The content of Si may be 0.46 mass % or more and 0.63 mass %, or may be 0.5 mass % or more and 0.6 mass % or less.

The content of Mg in the above-mentioned aluminum alloy may be 0.4 mass % or more and 0.6 mass % or less. In this case, compared to a case where the content of Mg is less than 0.4 mass %, it is possible to achieve both excellent tensile strength and elongation in the aluminum alloy wire 10, and compared to a case where the content of

Mg is more than 0.6 mass %, the aluminum alloy wire 10 is more excellent in conductivity. The content of Mg may be 0.45 mass % or more and 0.57 mass % or less, or 0.45 mass % or more and 0.55 mass % or less.

The content of Cu in the above-mentioned aluminum alloy may be 0.3 mass % or less. In this case, compared to a case where the content of Cu is more than 0.3 mass %, the aluminum alloy wire 10 is excellent in conductivity. The content of Cu may be 0.25 mass % or less. However, the content of Cu may be 0.03 mass % or more. The content of Cu may be 0.1 mass % or more and 0.2 mass % or less.

The content of Fe in the above-mentioned aluminum alloy may be 0.4 mass % or less. In this case, compared to a case where the content of Fe is more than 0.4 mass %, the aluminum alloy wire 10 is excellent in conductivity. The content of Fe may be 0.36 mass % or less, or 0.3 mass % or less. However, the content of Fe may be greater than 0 mass %. In this case, compared to a case where the content of Fe is 0 mass %, elongation of the aluminum alloy wire 10 can be further improved. The content of Fe may be 0.12 mass % or more.

The total content of Ti and V in the above-mentioned aluminum alloy may be 0.05 mass % or less. In this case, compared to a case where the total content of Ti and V is greater than 0.05 mass %, the aluminum alloy wire 10 is more excellent in conductivity. The total content of Ti and V may be 0.042 mass % or less, or 0.03 mass % or less. In addition, the total content of Ti and V may be 0.05 mass % or less and hence may be 0 mass %. That is, both the contents of Ti and V may be 0 mass %. Further, only the content of Ti among Ti and V may be 0 mass %, and only the content of V may be 0 mass %. However, the total content of Ti and V in the aluminum alloy may be 0.01 mass % or more.

In addition, the contents of Si, Fe, Cu and Mg, and the total content of Ti and V are based on the mass of the aluminum alloy wire 10 (100 mass %).

<Exothermic Peak>

The aluminum alloy wire 10 has an exothermic peak in a temperature range of 200 to 300° C. in a DSC curve obtained by conducting a differential scanning thermal analysis. In this case, compared to a case where the aluminum alloy wire 10 has no exothermic peak in a temperature range of 200 to 300° C., tensile strength and elongation of the aluminum alloy wire 10 can be further improved. The aluminum alloy wire 10 of the present invention has the exothermic peak in a temperature range of 230 to 275° C. in a DSC curve obtained by conducting a differential scanning thermal analysis. In this case, tensile strength and elongation can be further improved.

The calorific value in the exothermic peak is not particularly limited but may be 1.2 J/g or more. In this case, compared to a case where the calorific value is less than 1.2 J/g, elongation of the aluminum alloy wire 10 is more remarkably improved. The calorific value in the exothermic peak is 1.5 J/g or more. In this case, elongation is further improved. Further, the calorific value in the exothermic peak may still be 1.8 J/g or more. In this case, elongation is more further improved. The calorific value in the exothermic peak may be 2.9 J/g or more. In this case, elongation of the aluminum alloy wire 10 is even further improved. However, the calorific value in the exothermic peak may be 5.0 J/g or less. In this case, the tensile strength is further improved. The calorific value in the exothermic peak may be 4.8 J/g or less, or 4.3 J/g or less.

Examples of the exothermic peak include exothermic peaks derived from various phase transitions such as formation of a GP zone, precipitation of a β phase, precipitation of a β′ phase, precipitation of a β″ phase, the exothermic peak may be an exothermic peak derived from precipitation of the β″ phase. In this case, the tensile strength and elongation of the aluminum alloy wire 10 can be further improved.

The aluminum alloy wire 10 may include Mg₂Si. In this case, compared to a case where the aluminum alloy wire 10 contains no Mg₂Si, the tensile strength is further improved.

Next, a method of producing the aluminum alloy wire 10 will be described.

The method of producing the aluminum alloy wire 10 includes a rough drawing wire formation process of forming a rough drawing wire made of an aluminum alloy consisting of aluminum, an added element and inevitable impurities, the added element containing at least Si and Mg; a rough drawing wire treatment process of obtaining the aluminum alloy wire 10 by performing a treatment step to this rough drawing wire.

Next, the rough drawing wire formation process and the rough drawing wire treatment process mentioned above will be described in detail.

<Rough Drawing Wire Formation Process>

The rough drawing wire formation process is a process of forming the rough drawing wire made of the above-mentioned aluminum alloy.

The rough drawing wire mentioned above can be obtained by performing continuous casting and rolling, hot extrusion after billet casting or the like on molten metal made of the above-mentioned aluminum alloy, for example.

<Rough Drawing Wire Treatment Process>

The rough drawing wire treatment process is a process of obtaining the aluminum alloy wire 10 by performing a treatment step to the rough drawing wire.

<Treatment Step>

The treatment step includes a wire drawing treatment step, a solution treatment step, and an aging treatment step. As the treatment step, for example, the following example is shown.

First a wire drawing treatment step, followed by a solution treatment step, followed by a wire drawing treatment step, followed by a solution treatment step, and followed by an aging treatment step.

However, the treatment step is not limited to the above example. For example, the above example includes two wire drawing treatment steps, but the wire drawing treatment step may be performed once, or three or more times.

<Wire Drawing Treatment Step>

The above-mentioned wire drawing treatment step is a step of reducing a diameter of the rough drawing wire, a drawn wire material obtained by drawing the rough drawing wire, a drawn wire material obtained by further drawing the drawn wire material (hereinafter referred to as “rough drawing wire”, “drawn wire material obtained by drawing the rough drawing wire”, and “drawn wire material obtained by further drawing the drawn wire material” will be referred to as “wire materials”). The wire drawing treatment step may be a hot wire drawing or cold wire drawing, and typically be cold wire drawing.

<Solution Treatment Step>

The solution treatment step is a step in which a quenching treatment is performed after a solid solution of aluminum and the added element is formed. Here, formation of the solid solution is performed by performing heat treatment by heating the wire material at a high temperature and dissolving the added element which is not dissolved in the aluminum into aluminum.

The quenching treatment is a rapid cooling treatment performed on the wire material after the solid solution is formed. Rapid cooling of the wire material is performed in order to suppress precipitation of the added element dissolved in the aluminum during cooling, compared to a case where cooling is naturally performed. Here, rapid cooling means that cooling is performed at a cooling rate of 100 K/min or more.

In the solution treatment step, the heat treatment temperature at the time of forming the solid solution is not particularly limited as long as it is a temperature capable of dissolving the added element which is not dissolved in the aluminum into the aluminum, but it may be 450° C. or more. However, the heat treatment temperature at the time of forming the solid solution may be 600° C. or less. In this case, compared to a case where the heat treatment temperature is higher than 600° C., it is possible to more sufficiently suppress the partial dissolution of the wire material.

The heat treatment time at the time of forming the solid solution is not particularly limited, but from the viewpoint of sufficiently dissolving the added element which is not dissolved in the aluminum into the aluminum, may be 1 hour or more.

Rapid cooling can be performed using liquid, for example. As such a liquid, water or liquid nitrogen can be used.

<Aging Treatment Step>

The aging treatment step is a step in which an aging treatment of a final wire material is performed by forming precipitates in an aluminum alloy constituting the final wire material. Here, the final wire material means a wire material which has been already subjected to a wire drawing treatment step and to which further wire drawing treatment step is not performed. In the aging treatment step, the aluminum alloy wire 10 having a peak in a temperature range of 200 to 300° C. in a DSC curve obtained by conducting a differential scanning thermal analysis can be obtained by carrying out heat treatment in a temperature range of 100 to 180° C. for 1 to 72 hours. At this time, Mg₂Si may be as the precipitate.

The calorific value in the exothermic peak tends to become larger as the heat treatment time in the aging treatment is shortened. Therefore, in order to increase the calorific value, the heat treatment time in the aging treatment may be shortened. In order to reduce calorific value, the heat treatment time in the aging treatment may be increased.

<Electric Wire>

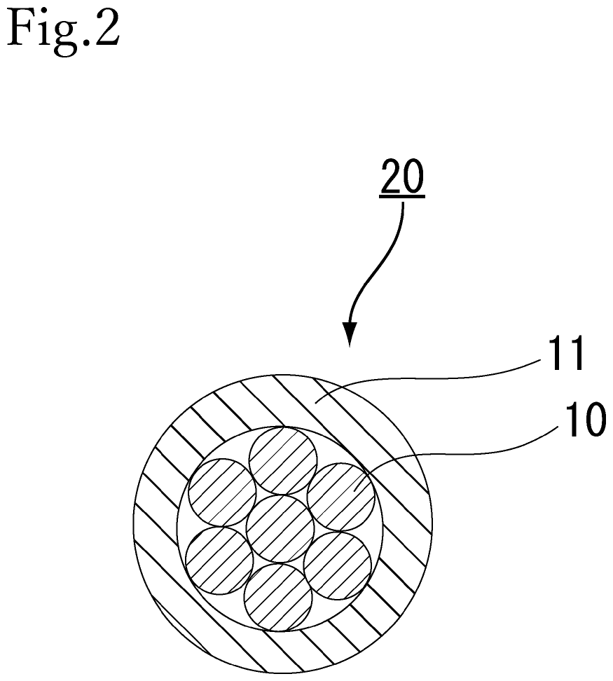

Next, an electric wire of the present invention will be described with reference to FIG. 2. FIG. 2 is a cross-sectional view illustrating an electric wire according to one or more embodiments of the present invention.

As illustrated in FIG. 2, the above-mentioned electric wire 20 includes the aluminum alloy wire 10 and a coating layer 11 covering the aluminum alloy wire 10. In addition, as illustrated in FIG. 2, the aluminum alloy wire 10 may be a single wire or may be a twisted wire obtained by twisting a plurality of single wires.

According to the electric wire 20, the aluminum alloy wire 10 can improve tensile strength and elongation. Therefore, the electric wire 20 having such an aluminum alloy wire 10 and the coating layer 11 covering the aluminum alloy wire 10 is useful as an electric wire disposed at a dynamic part to which bending or vibration is applied (for example, at a door part of an automobile, or in the vicinity of an engine of an automobile).

The electric wire 20 typically further includes the coating layer 11 covering the above-mentioned aluminum alloy wire 10. The coating layer 11 is composed of, for example, an insulating material such as a polyvinyl chloride resin or a flame retardant resin composition obtained by adding a flame retardant to a polyolefin resin.

The thickness of the coating layer 11 is not particularly limited, but is 0.1 to 1 mm, for example.

(Wire Harness)

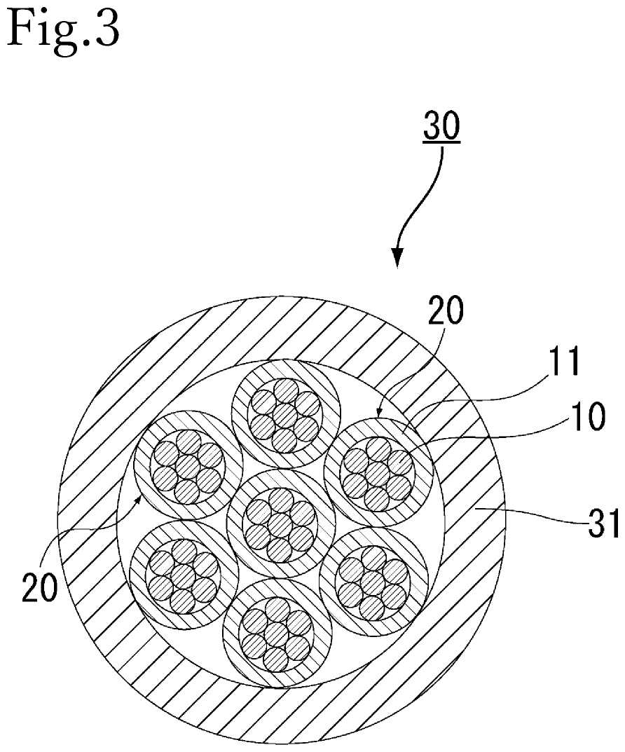

Next, a wire harness of the present invention will be described with reference to FIG. 3. FIG. 3 is a cross-sectional view illustrating the wire harness according to one or more embodiments of the present invention.

The wire harness 30 includes a plurality of the electric wires 20.

The wire harness 30 can improve tensile strength and elongation of the aluminum alloy wire 10. Therefore, the wire harness 30 having a plurality of the electric wires 20 each including such an aluminum alloy wire 10 and the coating layer 11 covering the aluminum alloy wire 10 is useful as a wire harness disposed at a dynamic part to which bending or vibration is applied (for example, at a door part of an automobile, or in the vicinity of an engine of an automobile).

In the wire harness 30, all of the electric wires 20 may have different wire diameters or may have the same wire diameters.

Further, in the wire harness 30, all of the electric wires 20 may be composed of aluminum alloys having different compositions, and may be composed of an aluminum alloy having the same composition.

Moreover, the number of electric wires 20 used in the wire harness 30 is not particularly limited as long as it is two or more, but it may be 200 or less.

### EXAMPLES

Hereinafter, the content of the present invention will be described more specifically with reference to Examples and Comparative Examples, the present invention is not limited to the following Examples.

### Examples 1 to 12 and Comparative Examples 1 to 9

An aluminum alloy having a wire diameter of 25 mm was cast by dissolving Si, Fe, Mg, Cu, Ti and V together with aluminum such that the contents of Si, Fe, Mg, Cu, Ti and V are as shown in Table 1, and then pouring into a mold having a diameter of 25 mm. Then, a rough drawing wire having a wire diameter of 9.5 mm was obtained by performing a swaging processing on thus obtained aluminum alloy with a swaging machine (manufactured by Yoshida Kinen Co., Ltd.) such that a wire diameter of 9.5 mm was obtained and then performing a heat treatment at 270° C. for 8 hours. An aluminum alloy wire was obtained by performing the following processing steps to thus obtained rough drawing wire.

In addition, in the solution treatment of the following treatment step, after a solid solution of aluminum and an added element is formed, a quenching treatment by water cooling was performed. The cooling rate of the quenching treatment at this time was 800 K/min. Further, the wire drawing was a cold wire drawing.

(Treatment Step)

First a wire drawing up to a wire diameter of 1.2 mm, followed by a solution treatment at 550° C. for 3 hours, followed by a wire drawing up to a wire diameter of 0.33 mm, followed by a solution treatment at 570° C. for 6 seconds, and followed by an aging treatment under “heat treatment condition in aging treatment” illustrated in Table 1

Further, for the aluminum alloy wires obtained as described above, a differential scanning thermal analysis was performed under the following conditions using DSC (product name “Diamond-Dsc”, manufactured by PerkinElmer, Inc.)) to obtain DSC curves. In the obtained DSC curves, the presence or absence of an exothermic peak appearing in a temperature range of 200 to 300° C. was confirmed. The results are shown in Table 1.

Standard material: Aluminum
Sample container: Aluminum
Temperature rising rate: 40° C./min
Sample weight: 20 mg
Atmosphere during analysis: Nitrogen

For the exothermic peak in 200 to 300° C. in the DSC curve obtained as described above, the heat of transition in the exothermic peak was calculated in accordance with JIS K7122, and the calculated heat of transition was determined to be “calorific value” of the exothermic peak. The results are shown in Table 1. The unit of “calorific value” is J/g. Further, for example, in Example 1 to 4 the peak temperatures of the exothermic peaks were 265° C., 261° C., 245° C. and 250° C., respectively.

<Characteristic Evaluation>

### <Tensile Strength and Elongation>

For Aluminum alloy wires of Examples 1 to 12 and Comparative Examples 1 to 9, tensile strength and elongation were measured by a tensile test according to JIS C3002. The results are shown in Table 1.

Furthermore, relative values of the tensile strength and elongation of Examples 1 to 12 and Comparative examples 1 to 9 in a case where tensile strength and elongation of Comparative Examples 1 to 9 are set to 100 were also shown. The results are shown in Table 1. In Table 1, the relative values of the tensile strength and elongation of Examples 1 to 4 are relative values in a case where the tensile strength and elongation of Comparative Example 1 are set to 100, respectively. The relative values of the tensile strength and elongation of Examples 5 to 12 are relative values in a case where the tensile strength and elongation of Comparative Examples 2 to 9 are relative values are set to 100, respectively.

TABLE 1

| | | | | | | | | | Heat |
|---|---|---|---|---|---|---|---|---|---|
| | Composition (mass %) | | | | | | | | Treatment |
| | | | | | | | | Al and | in |
| | | | | | | | | inevitabe | Aging |
| | Si | Fe | Mg | Cu | Ti | V | Ti + V | impurities | Treatment |
| Example 1 | 0.56 | 0.25 | 0.52 | 0.08 | 0.022 | 0.005 | 0.027 | balance | 120° C. × 24 h |
| Example 2 | 0.56 | 0.25 | 0.52 | 0.08 | 0.022 | 0.005 | 0.027 | balance | 160° C. × 3 h |
| Example 3 | 0.56 | 0.25 | 0.52 | 0.08 | 0.022 | 0.005 | 0.027 | balance | 160° C. × 12 h |
| Example 4 | 0.56 | 0.23 | 0.52 | 0.08 | 0.022 | 0.005 | 0.027 | balance | 160° C. × 24 h |
| Comparative Example 1 | 0.56 | 0.25 | 0.52 | 0.08 | 0.022 | 0.005 | 0.027 | balance | 200° C. × 8 h |
| Example 5 | 0.46 | 0.12 | 0.57 | 0.03 | 0.016 | 0.003 | 0.019 | balance | 130° C. × 8 h |
| Comparative Example 2 | 0.46 | 0.12 | 0.57 | 0.03 | 0.016 | 0.003 | 0.019 | balance | 200° C. × 8 h |
| Example 6 | 0.63 | 0.22 | 0.5 | 0.06 | 0.008 | 0.002 | 0.010 | balance | 140° C. × 8 h |
| Comparative Example 3 | 0.63 | 0.22 | 0.5 | 0.06 | 0.008 | 0.002 | 0.010 | balance | 200° C. × 8 h |
| Example 7 | 0.52 | 0.18 | 0.45 | 0.04 | 0.017 | 0.004 | 0.021 | balance | 150° C. × 8 h |
| Comparative Example 4 | 0.52 | 0.18 | 0.45 | 0.04 | 0.017 | 0.004 | 0.021 | balance | 200° C. × 8 h |
| Example 8 | 0.55 | 0.36 | 0.51 | 0.05 | 0.025 | 0.002 | 0.027 | balance | 140° C. × 8 h |
| Comparative Example 5 | 0.55 | 0.36 | 0.51 | 0.05 | 0.025 | 0.002 | 0.027 | balance | 200° C. × 8 h |
| Example 9 | 0.54 | 0 | 0.52 | 0.05 | 0.009 | 0 | 0.009 | balance | 140° C. × 8 h |
| Comparative Example 6 | 0.54 | 0 | 0.52 | 0.05 | 0.009 | 0 | 0.009 | balance | 220° C. × 8 h |
| Example 10 | 0.55 | 0.21 | 0.54 | 0.25 | 0.031 | 0.011 | 0.042 | balance | 140° C. × 8 h |
| Comparative Example 7 | 0.55 | 0.21 | 0.54 | 0.25 | 0.031 | 0.011 | 0.042 | balance | 220° C. × 8 h |
| Example 11 | 0.57 | 0.16 | 0.53 | 0 | 0.012 | 0.002 | 0.014 | balance | 150° C. × 8 h |
| Comparative Example 8 | 0.57 | 0.16 | 0.53 | 0 | 0.012 | 0.002 | 0.014 | balance | 200° C. × 8 h |
| Example 12 | 0.56 | 0.21 | 0.55 | 0.05 | 0 | 0 | 0 | balance | 140° C. × 8 h |
| Comparative Example 9 | 0.56 | 0.21 | 0.55 | 0.05 | 0 | 0 | 0 | balance | 200° C. × 8 h |

| | Exothermic Peak in | | | Tensile | | |
|---|---|---|---|---|---|---|
| | 200 to 300° C. | | | strength | | Elongation |
| | Presence | Calorific | Tensile | (Relative | | (Relative |
| | or | Value | strength | Value) | Elongation | Value) |
| | Absence | (J/g) | (MPa) | (%) | (%) | (%) |
| Example 1 | Presence | 4.3 | 246 | 103 | 16.7 | 288 |
| Example 2 | Presence | 2.9 | 244 | 102 | 15.2 | 262 |
| Example 3 | Presence | 1.5 | 284 | 118 | 11.1 | 191 |
| Example 4 | Presence | 0.9 | 290 | 121 | 8.4 | 145 |
| Comparative Example 1 | Absence | — | 240 | 100 | 5.8 | 100 |
| Example 5 | Presence | 2.6 | 238 | 104 | 13.2 | 264 |
| Comparative Example 2 | Absence | — | 229 | 100 | 5.0 | 100 |
| Example 6 | Presence | 3.2 | 245 | 101 | 13.9 | 323 |
| Comparative Example 3 | Absence | — | 242 | 100 | 4.3 | 100 |
| Example 7 | Presence | 2.4 | 257 | 108 | 10.8 | 270 |
| Comparative Example 4 | Absence | — | 237 | 100 | 4.0 | 100 |
| Example 8 | Presence | 3.6 | 248 | 102 | 14.7 | 283 |
| Comparative Example 5 | Absence | — | 242 | 100 | 5.2 | 100 |
| Example 9 | Presence | 3.4 | 237 | 110 | 11.2 | 295 |
| Comparative Example 6 | Absence | — | 215 | 100 | 3.8 | 100 |
| Example 10 | Presence | 3.6 | 262 | 104 | 13.6 | 296 |
| Comparative Example 7 | Absence | — | 251 | 100 | 4.6 | 100 |
| Example 11 | Presence | 2.9 | 255 | 104 | 11.2 | 193 |
| Comparative Example 8 | Absence | — | 245 | 100 | 5.8 | 100 |
| Example 12 | Presence | 3.3 | 244 | 102 | 14.8 | 264 |
| Comparative Example 9 | Absence | — | 239 | 100 | 5.6 | 100 |

From the results illustrated in Table 1, according to the aluminum alloy wire of the present invention, it was confirmed that the tensile strength and elongation of the aluminum alloy wire can be improved.

### EXPLANATIONS OF REFERENCE NUMERALS

10 . . . Aluminum alloy wire
20 . . . Electric wire
30 . . . Wire harness

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

1. An aluminum alloy wire containing impurities, the aluminum alloy wire comprising:
aluminum; and
an added element comprising Si and Mg,
wherein an exothermic peak of the aluminum alloy wire is in a temperature range of 200 to 300° C. on a differential scanning thermal analysis curve.

2. The aluminum alloy wire according to claim 1, wherein the exothermic peak is acquired from the precipitation of a β″ phase.

3. The aluminum alloy wire according to claim 1, wherein a calorific value in the exothermic peak is 1.2 J/g or more and 5.0 J/g or less.

4. (canceled)

5. The aluminum alloy wire according to claim 1, wherein
a content of the Si is 0.45 mass % or more and 0.65 mass % or less,
a content of the Mg is 0.4 mass % or more and 0.6 mass % or less,
a content of Cu in the aluminum alloy is 0.3 mass % or less,
a content of Fe in the aluminum alloy is 0.4 mass % or less, and
a total content of Ti and V in the aluminum alloy is 0.05 mass % or less.

6. The aluminum alloy wire according to claim 1, further comprising Mg₂Si.

7. An electric wire comprising:
the aluminum alloy wire according to claim 1; and
a coating layer covering that covers the aluminum alloy wire.

8. A wire harness comprising a plurality of the electric wire according to claim 7.
